(19) United States
(12) Patent Application Publication
(10) Pub. No.: US 2024/0291723 A1
(43) Pub. Date: Aug. 29, 2024

(54) COGNITIVE NETWORKS

(71) Applicant: Cisco Technology, Inc., San Jose, CA (US)

(72) Inventors: Jean-Philippe Vasseur, Combloux (FR); Grégory Mermoud, Venthône (CH)

(21) Appl. No.: 18/113,722

(22) Filed: Feb. 24, 2023

(51) Int. Cl. H04L 41/147; G06N 7/01

(52) U.S. Cl. CPC H04L 41/147; G06N 7/01

(57) ABSTRACT

In one embodiment, a device obtains cross-layer telemetry associated with an online application accessible via a network and from three or more layers of the network. The device estimates a quality of experience metric for the online application using the cross-layer telemetry as input to a cognitive model. The device selects a network action to increase the quality of experience metric estimated by the device. The device causes performance of the network action in the network.

### TECHNICAL FIELD

The present disclosure relates generally to computer networks, and, more particularly, to cognitive networks.

### BACKGROUND

For decades, computer networks have used Key Performance Indicator (KPIs) such as delay, loss, and jitter as proxies for the true user experience of online applications. More specifically, network administrators typically set different Service Level Agreements (SLAs) for different applications, under the assumption that there are certain KPI thresholds at which the user experience of an application becomes degraded. For instance, a voice application may be considered to give poor user experience when it violates an SLA such as: latency >300 ms or loss >3% or jitter >50 ms.

However, the link between different SLA thresholds and degraded application experience is often debatable and the granularity of the KPIs also makes the measured values largely irrelevant for this purpose. For instance, a network path experiencing a constant delay of 120 ms for a voice application over a period of ten minutes provides a very different user experience than a path with the same average delay that keeps varying between 20 ms and 450 ms. In other words, simply relying on traditional KPIs to detect degraded application experience is not enough, in many instances.

Further, even when the network is able to correctly identify degraded application experience, another challenge that remains is the appropriate network action that should be taken, to mitigate the degradation. For instance, determining that voice quality is low along a highly congested path may be relatively easy. However, determining the correct amount of bandwidth to allocate to the path or the appropriate queue weight for the traffic of the application still remains quite challenging.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for cognitive network control; and

FIG. 6 illustrates an example simplified procedure for performing cognitive networking.

### DESCRIPTION OF EXAMPLE EMBODIMENTS

### Overview

According to one or more embodiments of the disclosure, a device obtains cross-layer telemetry associated with an online application accessible via a network and from three or more layers of the network. The device estimates a quality of experience metric for the online application using the cross-layer telemetry as input to a cognitive model. The device selects a network action to increase the quality of experience metric estimated by the device. The device causes performance of the network action in the network.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

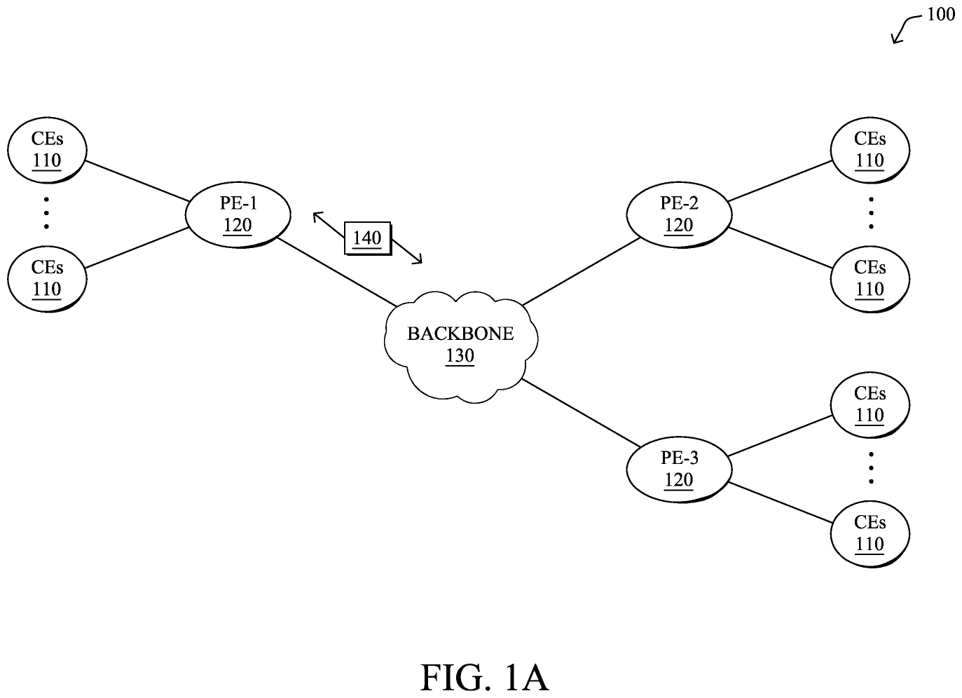

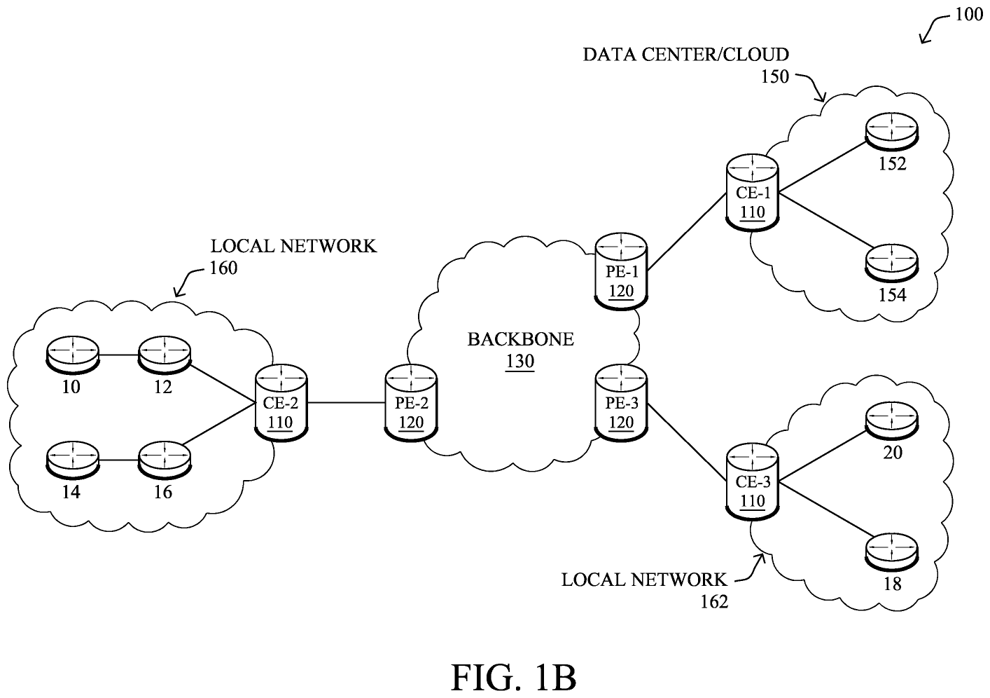

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

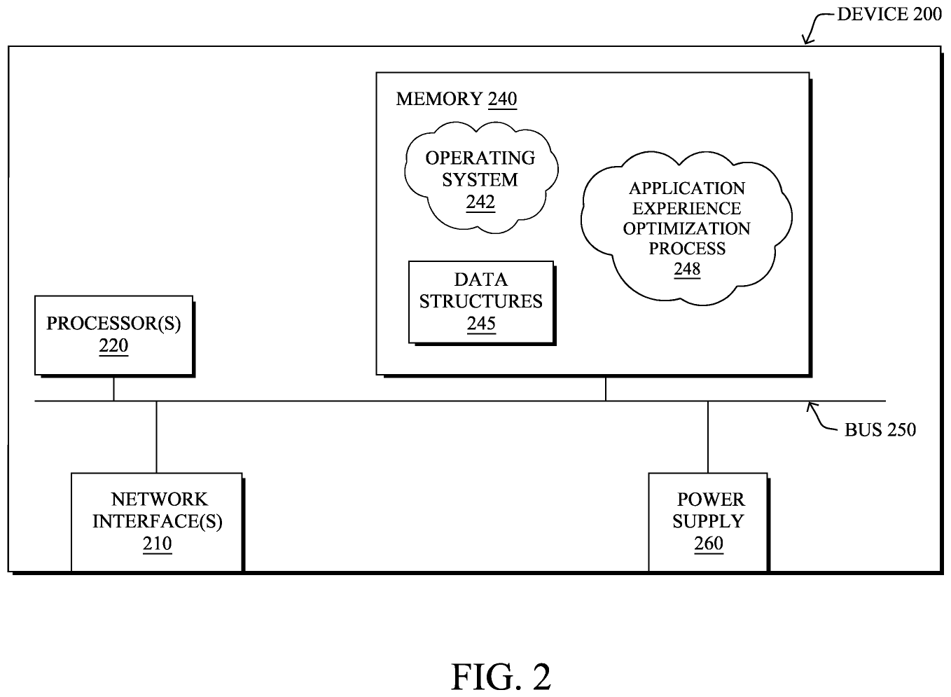

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an application experience optimization process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, application experience optimization process 248 contains computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, application experience optimization process 248 may consist solely of providing mechanisms necessary for source routing techniques. That is, for source routing, other devices in the network can tell the less capable devices exactly where to send the packets, and the less capable devices simply forward the packets as directed.

In various embodiments, as detailed further below, application experience optimization process 248 may include computer executable instructions that, when executed by processor(s) 220, cause device 200 to perform the techniques described herein. To do so, in some embodiments, application experience optimization process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, application experience optimization process 248 and/or data denoising process may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that application experience optimization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

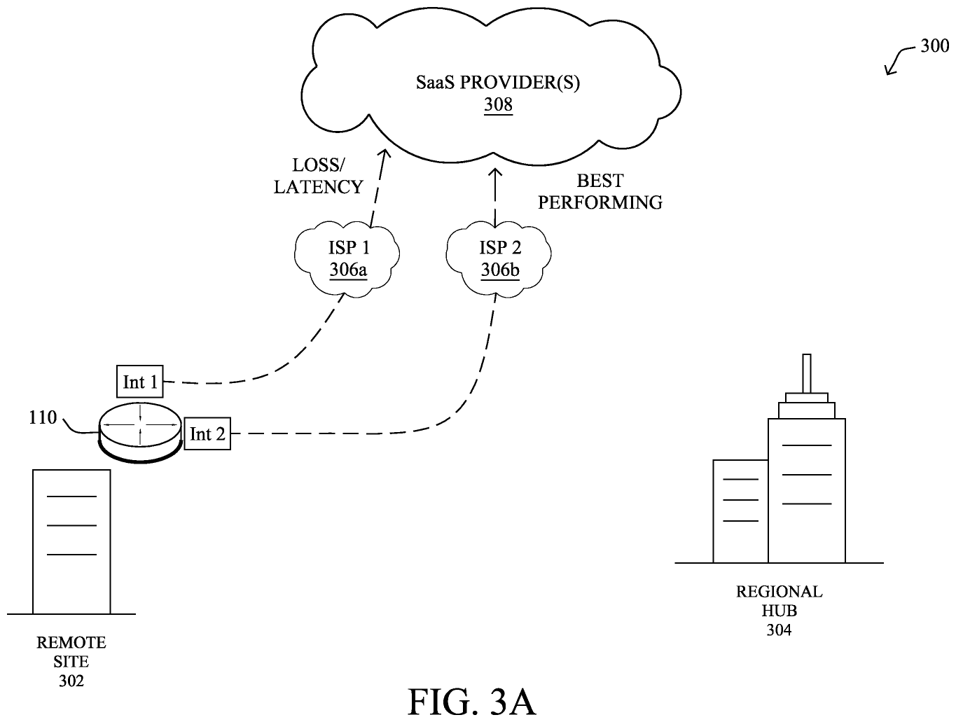

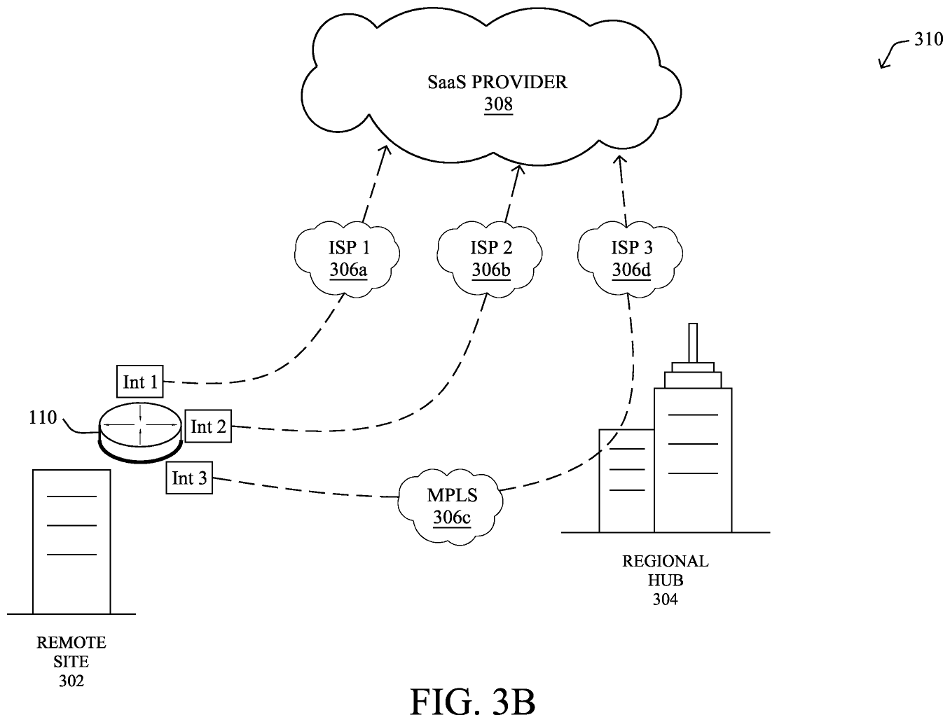

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

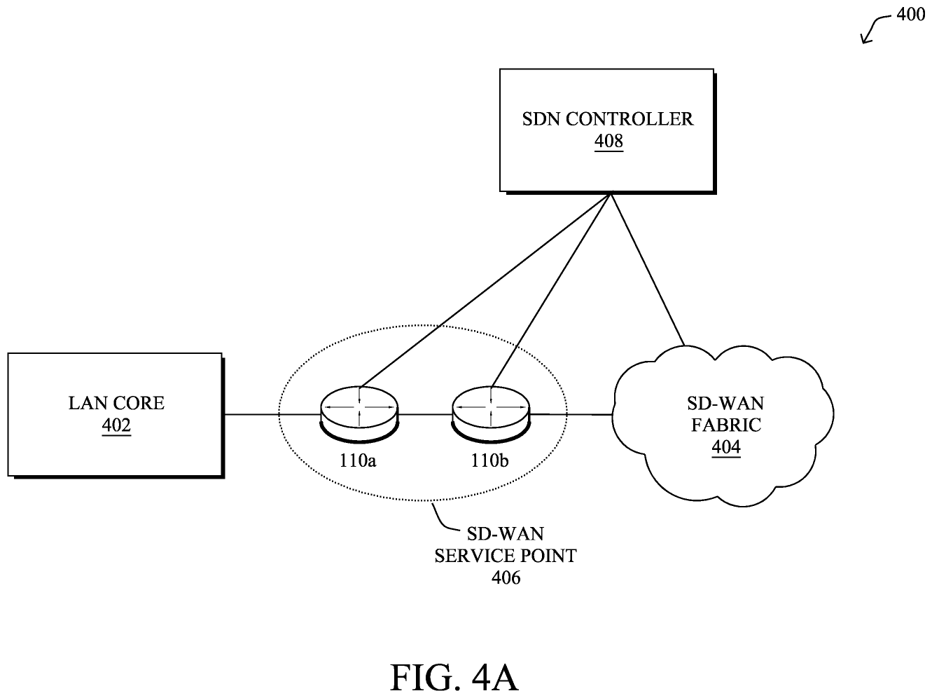

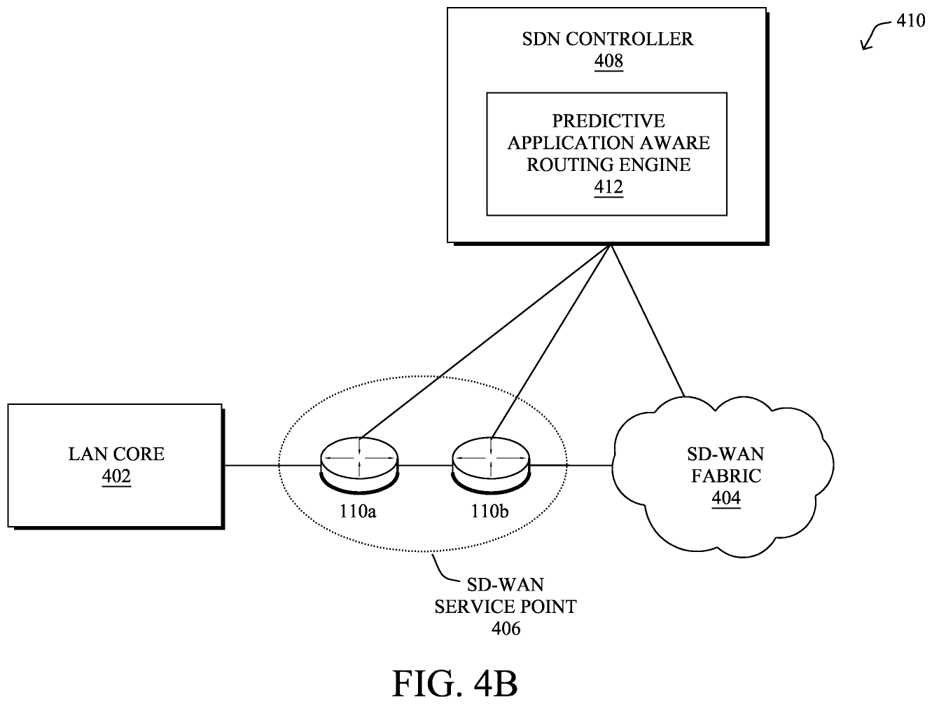

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance. SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side. SD-WAN provides a high degree of flexibility allowing for efficient configuration management using SDN controllers with the ability to benefit from a plethora of transport access (e.g., MPLS, Internet with supporting multiple CoS. LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of application experience optimization process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In other words, predictive application aware routing engine 412 may use SLA violations as a proxy for actual QoE information (e.g., ratings by users of an online application regarding their perception of the application), unless such QoE information is available from the provider of the online application. In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches.” which are typically temporary in nature (e.g., active for a specified period of time) and may also be application-specific (e.g., for traffic of one or more specified applications).

As noted above, for decades, computer networks have used Key Performance Indicator (KPIs) such as delay, loss, and jitter as proxies for the true user experience of online applications. More specifically, network administrators typically set different Service Level Agreements (SLAs) for different applications, under the assumption that there are certain KPI thresholds at which the user experience of an application becomes degraded. For instance, a voice application may be considered to give poor user experience when it violates an SLA such as: latency >300 ms or loss >3% or jitter >50 ms.

However, the link between different SLA thresholds and degraded application experience is often debatable and the granularity of the KPIs also makes the measured values largely irrelevant for this purpose. For instance, a network path experiencing a constant delay of 120 ms for a voice application over a period of of ten minutes provides a very different user experience than a path with the same average delay that keeps varying between 20 ms and 450 ms. The dynamics of such KPIs is even more important for packet loss and jitter, in the case of voice and video traffic (e.g. 10 seconds of 80% packet loss would severely impact the user experience although averaged out over 10 minutes would give a low value that is acceptable according to the SLA threshold). Thus, optimizing the user experience of an online application requires a more subtle and accurate approach to determine the networking requirements a path should meet in order to maximize the user satisfaction that takes into account both local phenomenon (e.g., the effects on delay, jitter and loss at higher frequencies) as well as telemetry from upper layers (e.g., applications).

Traditionally, a core principle of the Internet has been layer isolation. Such an approach allowed layer dependency (e.g. often referred to as layer violation) to be avoided, at a time where a number of protocols and technologies were developed at each layer. More specifically, the Open Systems Interconnection (OSI) model divides networks into seven networking layers:
1. The Physical (PHY) Layer—the layer representing the physical connections between devices
2. The Data Link Layer—e.g., the layer at which MAC addressing is used
3. The Network Layer—e.g., the layer at which the IP protocol is used
4. The Transport Layer—e.g., the layer at which TCP or UDP
5. The Session Layer—e.g., the layer at which a given session between endpoints is managed
6. The Presentation Layer—e.g., the layer that translates requests from the application layer to the session layer and vice-versa
7. The Application Layer—e.g., the highest layer at which the application itself operates

This allowed for the design and deployment of new layers (e.g. PHY, MAC, etc.) independent of each other, and allowing the Internet to scale. Still, with modern applications requiring tight SLAs, a cross-layer approach would be highly beneficial to optimizing the QoE of any given online application.

Further, even with a mechanism that is able to accurately estimate the application experience from the perspective of a user, another challenge still exists with respect to selecting the appropriate network action to improve the experience. Indeed, although the effect of specific actions at a given layer of the networking stack on user experience can be qualitatively evaluated, being able to precisely quantify it is often unknown. For instance, determining that voice quality is low along a highly congested path may be relatively easy. However, determining the correct amount of bandwidth to allocate to the path or the appropriate queue weight for the traffic of the application still remains quite challenging.

### Cognitive Networks

The techniques herein introduce the concept of cognitive networks. Instead of taking a siloed approach whereby networking systems poorly understand user satisfaction, focusing on singular networking layers, and often take non-ideal networking actions, cognitive networks are fully driven by understanding user experience (cognition) using cross-layer telemetry and ground truth user feedback, in order to determine which networking actions can optimize the user experience of a given online application. Such a holistic approach end-to-end across layers is a paradigm shift to how networks have been designed and operated since the early days of the Internet.

Illustratively, the techniques described herein may be performed by hardware, software, and/or firmware, such as in application experience optimization process 248, which may include computer executable instructions executed by the processor 220 (or independent processor of interfaces 210) to perform functions relating to the techniques described herein.

Specifically, according to various embodiments, a device obtains cross-layer telemetry associated with an online application accessible via a network and from three or more layers of the network. The device estimates a quality of experience metric for the online application using the cross-layer telemetry as input to a cognitive model. The device selects a network action to increase the quality of experience metric estimated by the device. The device causes performance of the network action in the network.

Operationally, the techniques herein introduce the concept of cognitive networks, which is a sharp departure from traditional approaches that rely on Layer-3 metrics to compute artificial QoE scores and trigger network actions using static rules and a trial-and-error approach. More specifically, the traditional approach to rectifying degraded application experience begins with a user complaining, followed by a network administrator trying to “fix” the issue by tuning network parameters such as by adding resources (e.g., increasing bandwidth, etc.) then performing some measurements using a Network Management System (NMS), and finally determining whether the satisfaction of the application's users has been improved. Of course, this still relies on using network KPIs or other proprietary formula as a proxy for the true satisfaction of the users.

In contrast, the concept of a cognitive network is based on the fundamental ability of the network to understand user satisfaction for a given application using cross-layer telemetry (concept of cognition) and determine which network actions should be triggered that will improve the user satisfaction. In various embodiments, cognitive networking exploits a rich set of signals (i.e., cross-layer telemetry), makes use of “model” of the world (i.e., networks) and trigger action with rewards (i.e., improve the QoE), similar to how the brain ingests stimuli, processes information to build a model of the world, and trigger actions. Such an approach is also a sharp deviation from “trial-and-error” approaches that measure the user satisfaction using proxy data, take (manual) actions (sometimes using inaccurate simulations and more often based on the experience of the network administrator), then measure the proxy data for the user satisfaction to check the efficacy of the approach. In contrast, the cognitive networking approach herein is capable of assessing (predicting) the user satisfaction and determining network actions that should be triggered to improve the user satisfaction, directly.

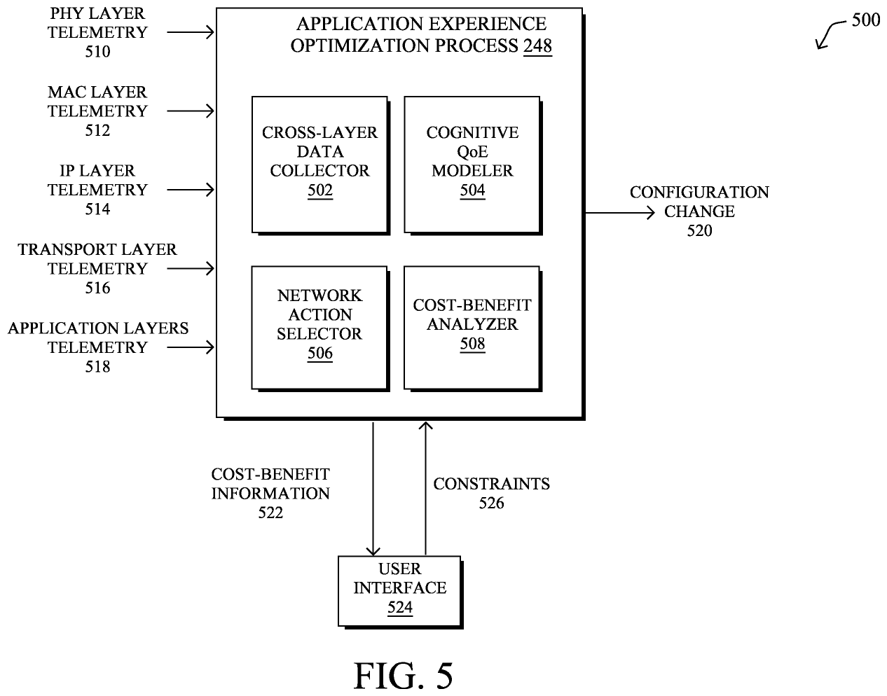

FIG. 5 architecture for cognitive network control, according to various embodiments. At the core of architecture 500 is application experience optimization process 248, which may be executed by a controller for a network, a networking device, or another device in communication therewith. For instance, application experience optimization process 248 may be executed by a controller for a network (e.g., SDN controller 408 in FIGS. 4A-4B), a particular networking device in the network (e.g., a router, etc.), another device or service in communication therewith, or any other device in a network. In some embodiments, for instance, application experience optimization process 248 may be used to implement a predictive application aware routing engine, such as predictive application aware routing engine 412, or another supervisory service for the network.

As shown, application experience optimization process 248 may include any or all of the following components: a cross-layer data collector 502, a cognitive QoE modeler 504, a network action selector 506, and/or a cost-benefit analyzer 508. As would be appreciated, the functionalities of these components may be combined or omitted, as desired (e.g., implemented as part of application experience optimization process 248). In addition, these components may be implemented on a singular device or in a distributed manner, in which case the combination of executing devices can be viewed as their own singular device for purposes of executing application experience optimization process 248.

During execution, cross-layer data collector 502 is responsible for collecting cross-layer telemetry from the network, in various embodiments. Indeed, telemetry is often now available from any or all of the various networking layers. For instance, cross-layer data collector 502 may obtain, either on a push or pull basis, any or all of the following data:
PHY layer telemetry 510—note that advanced chipset used for wireless, optical systems, and the like, are now capable of providing very fine-grained telemetry at ultra-high frequencies.
MAC layer telemetry 512
IP layer telemetry 514—e.g., based on Netflow (IPFIX) records, (fast) probes such as BFD, routing protocols Keep-Alive messaging, QoS statistics, or the like.
·Transport layer telemetry 516—e.g., Application Response Time (ART) for TCP flows, etc.
Application layers telemetry 518 (e.g., telemetry from any or all of Layers 5-7 of the OSI model)—e.g., such telemetry may be based on synthetic probes (e.g. time to load a web page, etc.) or native passive probes (e.g., Waterfalls for Web applications, etc.), as well as include application-specific telemetry (e.g. hundreds of variables reported by Webex for voice and video such as Concealment Time (CT), CODEC-related variables, etc.), or even labels provided by the application itself (e.g. Microsoft O365 may report four labels such as “Good”, “Degraded”, “Bad”, “No Opinion”, etc., which may be based on feedback provided directly by the users of that application).

According to various embodiments, cognitive QoE modeler 504 is responsible for assessing the user experience of a given online application based on its associated cross-layer telemetry collected by cross-layer data collector 502. To that end, it may compute a QoE model that is typically application-specific and leverages machine learning/artificial intelligence to estimate the application QoE given a set of cross-layer telemetry for that application.

As would be appreciated, traditional approaches to estimating the application QoE have relied on relied on KPI-based formulas. For example, most NMS and assurances solutions assign an application score using weights (degree of importance) and values to networking KPI variables, to compute a score between 1 and 5. In contrast, the model of cognitive QoE modeler 504 may be trained using ground truth labels. In various embodiments, such ground truth labels may take various form such as any or all of the following:
A number that represents the users' feedback regarding their satisfaction with their application experience (e.g., 1 to 5 “stars,” as used in many systems today).
A binary flag (e.g. “thumbs up”, “thumbs down”) that quantifies the users' feedback regarding their satisfaction.
Weak signals—while direct feedback from the users of the application are strong signals as to the true QoE of the application, there may also be other weak signals, such as detected events from the cross-layer telemetry that may also indicate the QoE. For instance, events such as a user suddenly disconnecting from the application or using a different network to connect, could indicate poor QoE. Similarly, assessing a call transcript and detecting that a user said the phrase “I cannot hear you” can also indicate poor QoE.

Application experience optimization process 248 may gather such ground truth labels offline or online and at various frequencies, as well. In the offline approach, application experience optimization process 248 could solicit feedback from network experts by providing pre-recorded captures of video conferences or sets of cross-layer telemetry. In the online approach, application experience optimization process 248 could ask for live feedback from users of the application during or after completion of a given task (e.g., a call). In either case, a key aspect here is that cognitive QoE modeler 504 relies on user feedback collection, with no a priori knowledge of what drives the QoE. Note also that cognitive QoE modeler 504 may not expect the ground truth labels to be “coherent, either, accounting for some level of subjectivity or ignorance of relevant variables among the users providing feedback. For instance, users in a country where the quality of the Internet is usually poor may not provide similar feedback than users living in regions where the Internet provides high quality of service.

In various embodiments, the model of cognitive QoE modeler 504 may take the form of a Deep Neural Network (DNN), a model based on ensemble learning such as a Gradient Boosted trees (GBT), a random forest, or other form of cognitive model trained using cross-layer telemetry as input features (after potential dimensionality reduction) using the ground truth labels listed above for regression (prediction of the user experience). The end result of this training is a model that is capable of assessing the user satisfaction using cross-layer telemetry (e.g., by estimating a QoE metric based on the cross-layer telemetry).

According to various embodiments, network action selector 506 may maintain a list of networking actions that can be used by application experience optimization process 248 to optimize the QoE of the online application under scrutiny. For example, network action selector 506 may be able to tune various parameters for specific MAC layers (e.g. Wi-Fi parameters, switching, etc.), QoE parameters (e.g., the number of queues, weights to serve queues, priorities, assignment of traffic to queues, etc.), IP parameters (e.g., network topology, link bandwidths, etc.).

In some embodiments, by policy, network action selector 506 may not be allowed to select certain network actions from among the full set of possible actions. For instance, one policy may prevent network action selector 506 selecting a change to the topology of the network, while allowing it to select changes to the configured bandwidth. In another example, the policy may generally allow network action selector 506 to tune the QoS by adapting the weights, but disallow changing the priorities. In other embodiments, the subset of actions may be specific to some users or some applications.

In one embodiment, network action selector 506 may use the QoE model of cognitive QoE modeler 504 to assess the QoE and, in a second step, leverage another learning model to improve QoE. For instance, network action selector 506 could use model interpretation techniques to understand which input feature drive the QoE (e.g. for example using Shapley values) in an attempt to root-cause the QoE. Based on the importance of input features, network action selector 506 may then trigger some actions and measure their impact on QoE using reinforcement learning, for instance.

In another embodiment, network action selector 506 may make use of differentiable programming (which can be seen as a generalization of Deep Neural networks), to optimize a given variable (e.g. user satisfaction aka QoE) using as input a set of telemetry feeding a (pre-trained) DNN, itself connected to a plurality of networking actions, all functions being differentiable and using a loss function reflecting the objective (improve QoE). In such a case, the output would then be a set of networking actions that can be implemented to improve the overall user satisfaction (QoE). Thus, as a result of the selection, network action selector 506 may then send a configuration change 520 to the relevant networking device(s) to implement the selected network action.

With the emergence of Software Defined Cloud Interconnect (SDCI) and Middle Mile Optimization (MMO) it even becomes possible for network action selector 506 to provision a network on-the-fly: new nodes (virtual routers) can easily be provisioned, with dynamic topology (“virtual” links interconnecting the routers) and even dynamic bandwidth. Although application programming interfaces (APIs) do exist today to provision such networks, there are currently no utilities that provide insights as to the best topologies and resources required to optimize some variables such as the user QoE. In contrast, network action selector 506 may determine which action to takes to achieve such an objective, a fundamental paradigm shift to existing network operations.

In some embodiments, cost-benefit analyzer 508 may record each action triggered by network action selector 506 and compute the cost-benefit metrics with respect to the target variable (e.g., the QoE). For example, cost-benefit analyzer 508 may discover that changing the QoS queue weight on most WAN links had almost no cost, deteriorated by x % the level of QoE for low priority traffic, and improved the user QoE by x′ %, whereas increasing the WAN link bandwidth increased the cost metric by c % but improved the QoE by z % with z>>x %. Such feedback could be used as input to network action selector 506 to help its selection of the appropriate network action.

In one embodiment, cost-benefit analyzer 508 may also provide the cost-benefit information 522 to a user interface 524, to allow a network administrator to review the cost-benefit metrics associated with the different actions. In some instances, the administrator may also specify, via user interface 524, constraints 526. In turn, network action selector 506 may use these constraints to limit the full set of possible network actions to only a subset for its selections in the future.

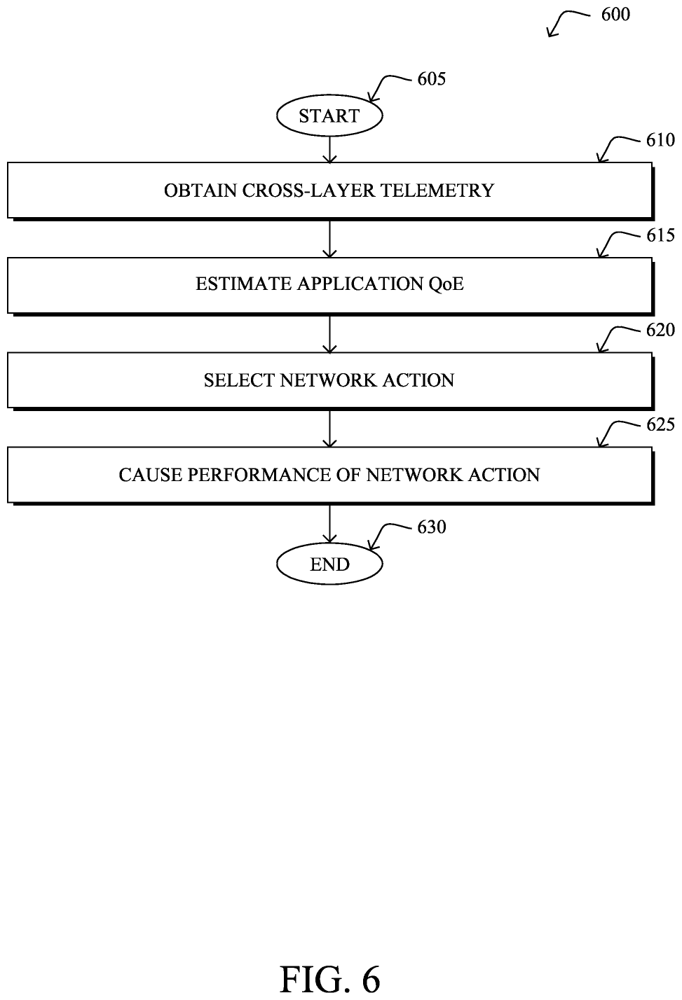

FIG. 6 illustrates an example simplified procedure 600 (e.g., a method) for providing recommendations to end users to ensure satisfactory application QoE, in accordance with one or more embodiments described herein. For example, a non-generic, specifically configured device (e.g., device 200), such as controller for a network (e.g., an SDN controller, a cloud-based device, etc.), an edge router, or other device in communication with a network, may perform procedure 600 by executing stored instructions (e.g., application experience optimization process 248). The procedure 600 may start at step 605, and continues to step 610, where, as described in greater detail above, the device may obtain cross-layer telemetry associated with an online application accessible via a network and from three or more layers of the network. In various embodiments, the cross-layer telemetry comprises physical layer telemetry, data link layer telemetry, network layer telemetry, transport layer telemetry, and application layer telemetry

At step 615, as detailed above, the device may estimate a quality of experience metric for the online application using the cross-layer telemetry as input to a cognitive model. In some embodiments, the device may also provide sets of the cross-layer telemetry for presentation to a user interface and receive ground truth labels indicative of quality of experience metrics for the sets of the cross-layer telemetry, whereby the cognitive model is trained in part using the ground truth labels. In further embodiments, the device may also identify events from the cross-layer telemetry as indicative of poor quality of experience metrics for the online application, and associate ground truth labels to sets of the cross-layer telemetry associated with the events, whereby the cognitive model is trained in part using the ground truth labels.

At step 620, the device may select a network action to increase the quality of experience metric estimated by the apparatus, as described in greater detail above. In some embodiments, the device may do so by selecting a particular layer of the three or more layers of the network to be optimized for the online application, whereby the network action adjusts a configuration at the particular layer of the network. In further embodiments, the device may compute cost-benefit metrics for each of a plurality of potential network actions and select the network action from among the plurality of potential network actions based on its associated cost and benefit metrics. In additional embodiments, the device may also provide the cost-benefit metrics for the plurality of potential network actions to a user interface; and, in response, receive a constraint from the user interface that limits selection of the network action from among the plurality of potential network actions to a subset of the plurality of potential network actions. In some embodiments, the device may select the network action from among a plurality of possible network actions according to a policy that prevents the device from selecting one or more of the plurality of possible network actions (e.g., a policy that prevents certain actions from being taken, entirely).

At step 625, as detailed above, the device may cause performance of the network action in the network. In various embodiments, the network action comprises provisioning a virtual node or link in the network.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for cognitive networking, it is to be understood that various other adaptations and modifications may be made within the spirit and scope of the embodiments herein. For example, while certain embodiments are described herein with respect to using certain models for purposes of predicting application experience metrics, application QoE, disruptions in a network, etc., the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, cross-layer telemetry associated with an online application accessible via a network and from three or more layers of the network;
identifying, by the device, events from the cross-layer telemetry as indicative of poor quality of experience metrics for the online application;
associating, by the device, ground truth labels to sets of the cross-layer telemetry associated with the events, wherein the ground truth labels comprise a weak signal that represents user feedback regarding the online application, further wherein a cognitive model is trained in part using the ground truth labels;
estimating, by the device, a quality of experience metric for the online application using the cross-layer telemetry as input to the cognitive model;
selecting, by the device, a network action to increase the quality of experience metric estimated by the device; and
causing, by the device, performance of the network action in the network.

2. The method as in claim 1, wherein the network action comprises provisioning a virtual node or link in the network.

3. The method as in claim 1, further comprising:
providing sets of the cross-layer telemetry for presentation to a user interface; and
receiving ground truth labels indicative of quality of experience metrics for the sets of the cross-layer telemetry, wherein the cognitive model is trained in part using the ground truth labels.

4. (canceled)

5. The method as in claim 1, wherein the cross-layer telemetry comprises physical layer telemetry, data link layer telemetry, network layer telemetry, transport layer telemetry, and application layer telemetry.

6. The method as in claim 1, wherein selecting the network action to increase the quality of experience metric estimated by the device comprises:
selecting a particular layer of the three or more layers of the network to be optimized for the online application, wherein the network action adjusts a configuration at the particular layer of the network.

7. The method as in claim 1, wherein selecting the network action to increase the quality of experience metric estimated by the device comprises:
computing cost-benefit metrics for each of a plurality of potential network actions; and
selecting the network action from among the plurality of potential network actions based on its associated cost and benefit metrics.

8. The method as in claim 7, further comprising:
providing the cost-benefit metrics for the plurality of potential network actions to a user interface; and, in response,
receiving a constraint from the user interface that limits selection of the network action from among the plurality of potential network actions to a subset of the plurality of potential network actions.

9. The method as in claim 1, wherein the device selects the network action from among a plurality of possible network actions according to a policy that prevents the device from selecting one or more of the plurality of possible network actions.

10. The method as in claim 1, wherein the device comprises a controller for the network.

11. An apparatus, comprising:
one or more network interfaces;
a processor coupled to the one or more network interfaces and configured to execute one or more processes; and
a memory configured to store a process that is executable by the processor, the process when executed configured to:
obtain cross-layer telemetry associated with an online application accessible via a network and from three or more layers of the network;
identify events from the cross-layer telemetry as indicative of poor quality of experience metrics for the online application;
associate ground truth labels to sets of the cross-layer telemetry associated with the events, wherein the ground truth labels comprise a weak signal that represents user feedback regarding the online application, further wherein a cognitive model is trained in part using the ground truth labels;
estimate a quality of experience metric for the online application using the cross-layer telemetry as input to a cognitive model;
select a network action to increase the quality of experience metric estimated by the apparatus; and
cause performance of the network action in the network.

12. The apparatus as in claim 11, wherein the network action comprises provisioning a virtual node or link in the network.

13. The apparatus as in claim 11, wherein the process when executes is further configured to:
provide sets of the cross-layer telemetry for presentation to a user interface; and
receive ground truth labels indicative of quality of experience metrics for the sets of the cross-layer telemetry, wherein the cognitive model is trained in part using the ground truth labels.

14. (canceled)

15. The apparatus as in claim 11, wherein the cross-layer telemetry comprises physical layer telemetry, data link layer telemetry, network layer telemetry, transport layer telemetry, and application layer telemetry.

16. The apparatus as in claim 11, wherein the apparatus selects the network action to increase the quality of experience metric estimated by the apparatus by:
selecting a particular layer of the three or more layers of the network to be optimized for the online application, wherein the network action adjusts a configuration at the particular layer of the network.

17. The apparatus as in claim 11, wherein the apparatus selects the network action to increase the quality of experience metric estimated by the apparatus by:
computing cost-benefit metrics for each of a plurality of potential network actions; and
selecting the network action from among the plurality of potential network actions based on its associated cost and benefit metrics.

18. The apparatus as in claim 17, wherein the process when executed is further configured to:
provide the cost-benefit metrics for the plurality of potential network actions to a user interface; and, in response,
receive a constraint from the user interface that limits selection of the network action from among the plurality of potential network actions to a subset of the plurality of potential network actions.

19. The apparatus as in claim 11, wherein the apparatus selects the network action from among a plurality of possible network actions according to a policy that prevents the apparatus from selecting one or more of the plurality of possible network actions.

20. A tangible, non-transitory, computer-readable medium storing program instructions that cause a device to execute a process comprising:
obtaining, by the device, cross-layer telemetry associated with an online application accessible via a network and from three or more layers of the network;
identifying, by the device, events from the cross-layer telemetry as indicative of poor quality of experience metrics for the online application;
associating, by the device, ground truth labels to sets of the cross-layer telemetry associated with the events, wherein the ground truth labels comprise a weak signal that represents user feedback regarding the online application, further wherein a cognitive model is trained in part using the ground truth labels;
estimating, by the device, a quality of experience metric for the online application using the cross-layer telemetry as input to a cognitive model;
selecting, by the device, a network action to increase the quality of experience metric estimated by the device; and
causing, by the device, performance of the network action in the network.
